(19) United States
(12) Patent Application Publication
(10) Pub. No.: US 2004/0038848 A1
(43) Pub. Date: Feb. 26, 2004

(54) Biocidal cloth

(76) Inventor: Steven Kritzler, Rosebery (AU)

Correspondence Address: PILLSBURY WINTHROP, LLP, P.O. BOX 10500, MCLEAN, VA, 22102, US

(21) Appl. No.: 10/275,812

(22) PCT Filed: May 10, 2001
(86) PCT No.: PCT/AU01/00530

(30) Foreign Application Priority Data
May 12, 2000 (AU) PA 7479

(51) Int. Cl. C11D 17/00

(52) U.S. Cl. 510/438

(57) ABSTRACT

A cleaning article including an agent or reagent, for example a biocidal agent or reagent, which is slowly released therefrom in use of the article and a visual indicator selected to present a change in appearance indicative of the amount of agent or reagent remaining in, or released from, the article. In preferred embodiments, the cleaning article comprises a nonwoven fabric or sponge containing one or more biocides which are slowly released during use, and bearing a crosslinked ink which fades during use at a rate which indicates when the article is no longer reliably biocidal. The invention also relates to a visual indicator for use on a cleaning article containing one or more biocides which are slowly released during use, said indicator consisting of an ink formulation which is crosslinked to a degree selected so that the ink will wear off or fade to a predetermined degree with the amount of usage that causes the biocide concentration to fall below an effective level. The amount of biocidal agent in or on a cleaning device when the agent is depleted or inactivated during use may be determined by comparing the appearance of the used cleaning device with the appearance of a corresponding unused cleaning device or a colour reference.

### FIELD OF THE INVENTION

The present invention relates to cleaning articles possessing biocidal or biostatic activity.

The invention has been developed primarily for use with biocidal cloths and will be described hereinafter with reference to this application. However, it will be appreciated that the invention is not limited to this particular field of use.

### BACKGROUND ART

The following discussion of the prior art is not to be construed as an admission with regard to the common general knowledge.

Biocidal cleaning articles are known in the art, for example, biocidal cloths such as those described in our copending application PCT/AU98/00984, the disclosure of which is incorporated herein by reference which has a biocidal agent bound to a cloth.

Cleaning articles are often used in the household to provide clean surfaces which will ultimately come into contact with substances such as foods and medicines, or which may directly contact hands and mouths. These cleaning articles are relied upon to provide hygienic surfaces. However, the fabric in conventional cleaning articles often provides ideal conditions, such as high nutrient and moisture levels, for the growth of bacterial colonies and fungi. Thus, rather than being an instrument for the removal of bacteria, these cleaning articles can in fact have the opposite effect and actively spread pathogens through their use.

The incorporation of biocidal material into the article, such as described in PCT/AU98/00984 can provide an article which not only attacks bacteria on a contaminated surface, but also prevents the growth of bacteria within the article itself. In PCT/AU98/00984 the extent and duration of biocidal activity are maximised by the use of slow release or binder formulations

Typically, these biocidal cleaning articles are initially highly efficacious against pathogens, although when subjected to repeated use and washing, the biocidal activity reduces to the point where the cleaning article is no longer able to maintain even within itself low levels of bacterial contamination. This cleaning article can then become unsafe to use, providing the user with a false sense of security in respect of the degree of protection provided against bacteria and other pathogens. Use of the cleaning article will then actively spread the pathogens. It is difficult however to predict or estimate the point at which the cleaning article loses its efficacy. This would depend on a number of factors such as the extent and duration of the use if the cleaning article, the number and type of washes, the roughness of the surface upon which the cleaning article has been used and the vigour of the user.

It is an object of the present invention to overcome or ameliorate at least some of the disadvantages of the prior art, or at least to provide a useful alternative.

### DESCRIPTION OF THE INVENTION

According to a first aspect the invention provides a cleaning article including an agent or reagent which is slowly released therefrom in use and a visual indicator selected to present a change in appearance indicative of the amount of agent or reagent remaining in, or released from, the article.

Preferably the article is a cloth or sponge. As herein used the term “cloth” includes non-woven fabrics and the term “sponge” includes artificial cellular foams.

Preferably, the agent or reagent is a biocidal agent or reagent.

Preferably, the change of appearance of the visual indicator is a change in colour or a change in colour intensity which is indicative of the amount of biocidal agent present in the cleaning device, or indicates if the amount of biocidal agent falls below a predetermined amount, for example below a safe effective amount.

Preferably, the invention provides an article according to the first aspect further including a cross-linking agent in the visual indicator.

According to a second aspect the invention provides a cleaning article including a nonwoven fabric or sponge containing one or more biocides which are slowly released during use, and bearing a crosslink-ed ink which fades during use at a rate which indicates when the article is no longer reliably biocidal.

According to a third aspect the invention provides a visual indicator for use on a cleaning article containing one or more biocides which are slowly released during use, said indicator consisting of an ink formulation which is crosslinked to a degree selected so that the ink will wear off or fade to a predetermined degree with the amount of usage that causes the biocide concentration to fall below an effective level.

According to a fourth aspect the invention provides a method of determining the amount of biocidal agent in or on a cleaning device when the agent is depleted or inactivated during use, including the step of visually comparing the appearance of the used cleaning device with the appearance of a corresponding unused cleaning device or a colour reference.

According to a fifth aspect the invention provides a kit including a biocidal cleaning article according to the first or second aspects and a colour reference which when compared with the colour or colour intensity of the indicator indicates when the article is no longer effective.

### BEST MODES OF PERFORMING THE INVENTION

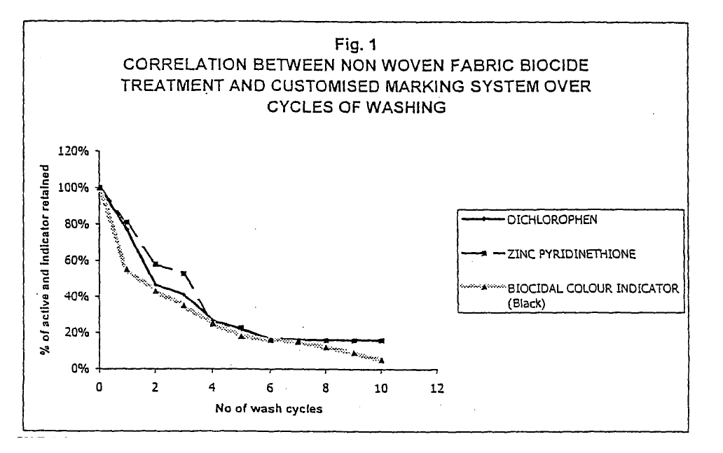

FIG. 1 shows the correlation between print fading and biocide wash out on a non-woven cloth of the present invention.

A preferred embodiment of the invention will now be described by way of example only.

The present invention in one aspect relates to a biocidal cloth of the type defined in PCT/AU98/00984 which further includes a black ink formulation which fades in colour intensity at substantially the same rate as the concentration of the biocide in the cloth reduces. Thus, as the biocidal agent is depleted from the biocidal cloth, the ink will fade in colour intensity.

The ink is imprinted in the form of text, indicating that biocidal activity was present. The fading of this text in use would indicate a lessening of biocidal activity and guide the user as to when the use of the cloth for hygiene purposes should be discontinued. It will be appreciated by those skilled in the art that the fading of ink may also be used to reveal an underprinted message, indicating that the cloth was becoming unsafe. The ink may be in the form of a colour patch, the intensity of which can be compared with a non-fading standard, for example a non-fading standard enclosed with the packaging or perhaps imprinted in non-fading ink elsewhere on the cloth. Many variations are possible within the broad concept of the invention.

The biocidal cleaning apparatus described in PCT/AU98/00984 includes a biocidal concentrate, and a binder formulation which are applied to a fabric. An example of the biocidal concentrate is given in Example 1, and a suitable binder formulation in Example 2.

### EXAMPLE 1

### Biocidal Concentrate

| Raw material | % w/w |
|---|---|
| zinc pyridine thione | 17.19 |
| dichlorophen | 34.39 |
| mineral oil | 22.92 |
| PVP | 8.44 |
| ethanol | 3.44 |
| sodium lauryl ether sulfate | 0.70 |
| dioctyl sulfosuccinate | 1.5 |
| water QS | 100 |

### EXAMPLE 2

### Binder Formulation

| Raw material | % w/w |
|---|---|
| acrylic polymer self-cross-linking binder | 46 |
| emulsion (approx. 56% solids) | |
| defoamer emulsion (foam master, Henkel) | 0.15 |
| acrylic copolymer viscosity controlling | 3.60 |
| emulsion (laterkol DG, BASF) | |
| sodium dioctyl sulfocuccinate | 1.0 |
| ammonium hydroxide (30%) | 1.0 |
| ammonium nitrate | 1.0 |
| distaff dispersion to standard colour | QS |
| water | 47.25 |

### EXAMPLE 3

### Application to Fabric

Bails of textile fibre are fed into a machine for making bonded, carded or hydroentangled non-woven fabric. These fibres can be of one type alone or of various combinations, for example made from either rayon fibres or a combination of rayon and polyester fibres.

In the bonded, carded process, the fibres are tangled together by one or more carding units in the series, whereas the entangling takes place using high pressure water jets in hydroentangling. In both cases, at the end of the entangling stage the material is in continuous web form and is quite damp due to residual water which has been used in the course of each process.

This damp continuous web is then printed using a suitable dilution of the concentrate of Example 1 and a binder of Example 2.

The biocidal cloth is now ready to be printed with the ink, although it is possible to carry out this printing stage after the binding agent has been cross-linked, by for example heating by means of steam heated drums over which the fabric passes and then dries by contact, or else by heating with infrared lamps which heat by radiation.

### EXAMPLE 4

### Two Component Ink Formulation

| Phase | Materials | % w/w | |
|---|---|---|---|
| A | Nuplex Texicryl 13-0111 resin | 29.370 | |
| | Propylene Glycol | 1.438 | |
| | Defoamer III | 0.306 | |
| | Kathone LX-1% solution | 0.155 | |
| | Water | 23.188 | |
| | Monoethanol amine | 1.544 | |
| B | Carbon Black | 14.850-13.500 | |
| | Glascol LS/34 resin | 18.150-16.500 | |
| C | Lucidene 606 LS | 14.000 | |
| TOTAL | | 103.0˜100.0 | |
| D | Pentaerythritol-tris-(B-(-azirindinyl) | 0.010 | max |
| | propionate) | | |

A two component ink can be applied to the biocidal cloth produced in Example 3.

Phases A, B and C are combined prior to the printing process. Texicryl 13-0111 is a reactive acrylic copolymer latex with an active content of between 35 and 55%. Defoamer III is a non silicone defoaming emulsion. Kathone LX is a preservative.

Carbon black provides the necessary colour depth to the printing of the indicator. Glascol LS/34 resin an aqueous solution of an acrylic styrene copolymer. Lucidene 606 LS is a styrene/acrylic copolymer latex of between 52 and 54% active content.

Just before the mixture is about to be printed, the pentaerythritol-tris-(B-(-azirindinyl) propionate) is added to the other components. The pentaerythritol-tris-(B-(-azirindinyl) propionate) is a cross-linking agent, the concentration of which controls the degree of cross-linking of the rest of the formulation.

The cross-linkable flexographic ink so formed is then printed upon the biocidal article and heated to effect cross-linking. The heating is effected by means of a heated drum or by infrared heating lamps, or by a combination of both.

In an alternative embodiment, the biocidal formulation of Example 1, and the binder of Example 2 are applied either simultaneously or in sequence with the ink prior to any cross-linking and the whole is then cross-linked as described.

### EXAMPLE 5

### One-Component Flexographic Ink

| Material | % w/w |
|---|---|
| Benzedine Yellow No 12 (powder) | 12.0 |
| Glascol 86 TX Resin Powder | 30.0 |
| Monoethanol amine | 1.2 |
| Glascol TA | 4.0 |
| Alcalube CRT 40% | 5.0 |
| Defoamer AC | 0.1 |
| Water | 47.7 |
| TOTAL | 100 |

In an alternative to Example 4, a single component ink may be applied to the biocidal cloth to provide an indication of the remaining efficacy of the agents bound to the cloth. A suitable single component ink system is shown in Example 5.

### EXAMPLE 6

### Correlation of Colour Intensity With Bound Biocide

FIG. 1 demonstrates the high degree of correlation between the rate of fading of the print on the non-woven cloth with the rate of wash out of the biocide bound into the cloth.

The perception of colour indicator strength was rated on a scale of 1-10 by members of a test panel and averaged across the panel.

The correlation has only been followed for 10 cycles of washing because this is the standard number of laundry washing cycles which correlates to the end of the useful life in the kitchen of this type of non-woven fabric. However just as a functional ink was formulated to correlate with the biocidal washout for this cloth similarly inks can be formulated to correlate with the standards for other non-woven or woven fabrics.

Although the invention has been described with reference to specific examples, it will be appreciated by those skilled in the art that the invention may be embodied in many other forms.

The claims of the invention are as follows:

1. A cleaning article including an agent or reagent which is slowly released therefrom in use of the article and a visual indicator selected to present a change in appearance indicative of the amount of agent or reagent remaining in, or released from, the article.

2. An article according to claim 1 wherein the agent or reagent is a biocidal agent or reagent.

3. An article according to claim 1 or claim 2 wherein the article is a cloth or sponge.

4. An article according to claim 3 which is a nonwoven cloth.

5. An article according to any one of claims 1 to 4 wherein the visual indicator is an ink or dye, which undergoes a change in colour or a change in colour intensity with use of the article and wherein the change is indicative of the amount of biocidal agent remaining in the cleaning device.

6. An article according to any one of claims 1 to 4 wherein the visual indicator is a coating which becomes increasingly transparent to a degree indicative of the amount of agent or reagent remaining in the cleaning device.

7. An article according to claim 6 wherein the visual indicator includes one or more symbols or indicia underlying said coating and which becomes visible through the coating to a degree indicative of the amount of agent or reagent remaining in the cleaning device.

8. An article according to any one of claims 1 to 4 wherein the visual indicator is an ink or dye, which undergoes a change in colour or a change in colour intensity with use of the article indicative of when the amount of biocidal agent remaining in the cleaning device falls below a predetermined level.

9. An article according to any one of claims 1 to 4 wherein the visual indicator is a coating which becomes increasingly transparent to a degree indicative of when the amount of biocidal agent remaining in the cleaning device falls below a predetermined level.

10. An article according to any one of the preceding claims wherein the visual indicator is a flexography ink.

11. An article according to claim 110 wherein the colour intensity of the ink fades in use of the article.

12. An article according to anyone of the preceding claims wherein the visual indicator is a crosslinked composition, the degree of crosslinking being selected so that during use the rate of loss of the indicator composition correlates with the rate of loss of said agent or reagent.

13. An article according to claim anyone of the preceding claims wherein the visual indicator is applied to the article in a thickness such that during use the indicator composition is substantially depleted when the agent or reagent falls below a predetermined concentration.

14. An article according to any one of the preceding claims wherein the agent or reagent is selected from dichlorophen, zinc pyridinethione, and combinations thereof.

15. A cleaning article including a nonwoven fabric or sponge containing one or more biocides which are slowly released during use, and bearing a crosslinked ink which fades during use at a rate which indicates when the article is no longer reliably biocidal.

16. A visual indicator for use on a cleaning article containing one or more biocides which are slowly released during use, said indicator consisting of an ink formulation which is crosslinked to a degree selected so that the ink will wear off or fade to a predetermined degree with the amount of usage that causes the biocide concentration to fall below an effective level.

17. A visual indicator according to claim 16 including a reactive acrylic polymer latex.

18. A method of determining the amount of biocidal agent in or on a cleaning device when the agent is depleted or inactivated during use, including the step of visually comparing the appearance of the used cleaning device with the appearance of a corresponding unused cleaning device or a colour reference.

19. A kit including a biocidal cleaning article according to any one of claims 1 to 15 and a colour reference which when compared with the colour or colour intensity of the indicator indicates when the article is no longer effective.
